(19) United States
(12) Patent Application Publication
(10) Pub. No.: US 2008/0087710 A1
(43) Pub. Date: Apr. 17, 2008

(54) RAPID, REDUCED TEMPERATURE JOINING OF ALUMINA CERAMICS WITH Ni/Nb/Ni INTERLAYERS

(75) Inventor: Andreas M. Glaeser, Berkeley, CA (US)

Correspondence Address: LAWRENCE BERKELEY NATIONAL LABORATORY, ONE CYCLOTRON ROAD, MAIL STOP 90B, UNIVERSITY OF CALIFORNIA, BERKELEY, CA, 94720, US

(73) Assignee: THE REGENTS OF THE UNIVERSITY OF CALIFORNIA, Oakland, CA (US)

(21) Appl. No.: 11/759,213

(22) Filed: Jun. 6, 2007

Related U.S. Application Data
(60) Provisional application No. 60/804,058, filed on Jun. 6, 2006.

(51) Int. Cl. B23K 31/02

(52) U.S. Cl. 228/121

(57) ABSTRACT

Multilayer Ni/Nb/Ni interlayers form thin transient liquid films at reduced temperatures that enable the rapid joining of alumina ceramics, and produce joints of reliably high strength. Bulk alumina with polished and as-ground bonding surfaces have been successfully joined. The overall interlayer composition can exceed 95% Nb, and thereby provide an excellent thermal expansion match to alumina, alumina-matrix composites, and other materials. Fabrication of joints suitable for high-temperature applications is possible.

### CROSS-REFERENCE TO RELATED APPLICATIONS

This application claims priority to U.S. Provisional Patent Application 60/804,058, filed Jun. 6, 2006, which is incorporated by reference herein.

### STATEMENT OF GOVERNMENTAL SUPPORT

The invention described herein was made in part utilizing funds supplied by the Director, Office of Science, Office of Basic Energy Sciences, Division of Materials Sciences and Engineering, of the U.S. Department of Energy under Contract No. DE-AC03-76SF00098, and in part utilizing funds supplied by the National Science Foundation under Contract No. DMI-0522652. The government has certain rights in this invention.

### BACKGROUND OF THE INVENTION

1. Field of the Invention

This invention relates generally to a method of joining materials, and, more specifically, to a fast, low temperature method of joining ceramics to or with low thermal expansion coefficient refractory metals.

2. Background

In a wide range of industries and applications, the manufacturing of a product or device requires the assembly or joining of smaller components. Ideally, the ultimate performance characteristics of a joined assembly will reflect the performance characteristics of the components that are joined, but, the overall properties can also be limited by the joints themselves in either a direct or indirect manner. If the joint region constitutes either a mechanical or chemical weak link, and is a preferred site for failure under load or an easy avenue for chemical attack, the joint can directly limit the performance characteristics or lifetime of the assembly. If the components that need to be joined include materials with temperature-sensitive microstructures, then the exposure of the material to elevated temperature during bonding can contribute to property/performance degradation.

Joining is critical to the fabrication of structures and devices for use in aerospace, biomedical, chemical, electronic, mining, and other applications. Ideally, joining enables the fabrication of large, complex, multi-material, multifunctional assemblies with novel or enhanced properties through the controlled integration of smaller, less complex, more easily manufactured parts. Joining also has the potential to allow repair of damaged structures through the replacement of defective components, thereby extending assembly lifetimes, and permitting the reuse of costly nonrecyclable components, e.g., fiber-reinforced materials. The beneficial economic and environmental impacts are obvious.

The aforementioned temperature sensitivity can have several origins. In some cases, it is the result of microstructures that are very fine scale, and therefore prone to coarsening (as in precipitation-hardened alloys and metal-supported catalysts) or capillary instabilities (Rayleigh instabilities in nanorods or nanowires, thin film dewetting), or both. The rates of these diffusional processes will increase with temperature and with decreasing dimensional scale. With the current emphasis on nanostructures, the latter will likely be an issue of growing importance. In other cases, the microstructure can be fragile in other ways and prone to degradation (or more drastic changes) if the sample is exposed to temperatures above a threshold temperature for too long a period of time. As examples, polycrystalline diamond coatings degrade if exposed to temperatures above ˜700° C., and metallic and oxide glasses that are exposed to elevated temperature can crystallize. Additional situations arise in which the components to be joined react above a certain temperature, or the components react with the joining media above some critical temperature. In some applications, for which the ultimate service temperature is low, it may be possible to produce adequate joints at sufficiently low temperature by soldering, brazing or other sealing methods. However, braze and solder joints often soften at temperatures well below the original joining temperature. Thus, such methods may be inappropriate for applications where the joined assembly is subjected to prolonged periods at elevated temperature, possibly under stress. In the absence of viable alternative routes to joining, a useful product cannot be manufactured.

The situation described is one that has arisen in many fields, and in some cases, elegant solutions have been developed. A classic example is the development of transient-liquid-phase (TLP) joining methods for the joining of turbine blades. To preserve the microstructure and properties of these engine components, and to avoid the deformation that would arise if solid-state bonding methods were used, an approach involving the use of a homogeneous braze layer that contains a uniformly distributed, rapidly diffusing, melting point depressant (MPD) was developed. Using Ni-rich, B-containing alloys, with a melting point below that of the turbine blade materials, it was possible to execute joining at temperatures sufficiently low to preserve the microstructure and properties. During bonding, the B, which serves as the MPD, rapidly diffuses by an interstitial mechanism into the adjoining Ni-base alloy, and alloying elements in the turbine counterdiffuse into the joint region. The liquid phase diminishes in quantity with time at the bonding temperature, and disappears isothermally. This isothermal solidification is at the core of transient liquid phase (TLP) bonding approaches. A liquid containing a MPD that diffuses rapidly into the adjoining material provides an opportunity to join at reduced temperature while preserving the potential for use at temperatures approaching the joining temperature.

Unfortunately, it has been difficult to extend the TLP approach to joining of ceramics. Approaches using multilayer interlayers were developed independently by Tino in Japan (Y. Tino, “Partial transient liquid phase metals layer technique of ceramic-metal bonding” J. Mater. Sci. Lett., 10, [2], 104-106 (1990)), and by Glaeser in the U.S. (A. M. Glaeser, “Low Temperature Transient Liquid Phase Ceramic Joining,” U.S. Pat. No. 5,234,152; issued Aug. 10, 1993), both of which are included by reference herein. The methods rely on multilayer metallic interlayers with a relatively thick, high-melting-point core layer designed to improve the thermal expansion match with the ceramic and to confer good high-temperature properties, and thin cladding layers of a lower-melting point material that provide a liquid phase that facilitates gap filling and interface formation at reduced temperature. Bonding is carried out in a temperature range that causes the cladding to melt, but keeps the core in solid form. For this variant of TLP bonding, the core-cladding combination is chosen such that the cladding constituent dissolves in the core material, and with time, forms a core-material-rich interlayer with high solidus temperature. Examples of interlayers based on this approach include thin Cu cladding layers with thicker Ni or 80Ni20Cr core layers. Bonding is executed at 1150° C., above the melting point of Cu but below the melting point of Ni, and yields homogenized interlayers with solidus temperatures that approach those of the core layer. When Cu/Pt/Cu interlayers are used, the solidus temperature of the homogenized interlayer can be several hundred degrees Celsius above the original joining temperature. Schematic illustrations of the initial interlayer design and a partially homogenized interlayer are provided in FIGS. 1a and 1b, respectively.

An alternative approach to joining, also based on multilayer interlayers, seeks to design interlayers in which the liquid is a “permanent” feature. Such interlayers take advantage of fundamentally different types of phase diagrams, and thus provide a complementary approach to one in which interlayer homogenization is the goal. The liquid can be a permanent feature at the joining temperature for either thermodynamic reasons—the cladding layer has limited solubility in the core layer—or for kinetic reasons—the diffusion of the cladding component into the core layer is very slow. In this technique, referred to as liquid film-assisted joining (LFAJ), the liquid dissolves some of the core layer material, and thus provides a rapid transport route for the core layer constituent. Flow of the liquid into interfacial gaps relies on the sum of the contact angles of the liquid on the ceramic and on the metal being less than 180°. If the sum of the liquid/core layer and liquid/ceramic interfacial energies exceeds that of the core/ceramic interfacial energy, then it is expected that the liquid film will ultimately break up into discrete droplets. This has been seen for Cu-rich liquids interspersed between Nb core layers and alumina ceramics of varying purity. Points and lines of contact develop between the core layer and the ceramic due to surface roughness, grain boundary grooving and ridge formation, and surface instability (microfaceting). If the interfacial energetics are within the desired range, once such points or lines of contact are formed, they grow at a rate that is limited by flux of the core layer material through the liquid. The process of contact area formation between the core layer and the ceramic proceeds by a process that is similar to heterophase liquid-phase sintering. Ultimately, the liquid phase becomes isolated and due to capillary instabilities forms isolated liquid droplets along the core layer/ceramic interface, as illustrated schematically in FIG. 1c. The residual area fraction of this dispersed phase can be quite small (<10%), and if the phase is ductile, interfacial fracture involves tearing of this phase, a process that enhances the interfacial fracture toughness.

Polycrystalline (99.5% and 99.9% pure) Al₂O₃, as well as sapphire substrates (99.994% pure) were bonded using multilayer Cu/Nb/Cu interlayers with Cu layers ranging from 0 to 5.5 μm thick, and a 99.99% pure 127-μm-thick Nb foil. To assess surface roughness effects, Al₂O₃ substrate surface finishes ranged from a mirror-smooth optical finish to an “as ground” finish produced by a 400-grit wheel on a surface grinder. Samples for mechanical testing were bonded at 1400° C. in a vacuum hot press with a 2 MPa load applied for 6 h. Beams ˜3 mm×˜3 mm in cross section and ˜4 cm in length, with the metal interlayer at the beam center, were prepared and tested at both room temperature and at a series of elevated temperatures. The color contrast between Cu and Nb allowed model studies of the interfacial microstructure evolution. Sapphire samples were bonded and annealed at either 1150° C. or 1400° C. to allow nondestructive examination of the interlayer/sapphire interface using optical microscopy. Cross-sections normal to the bond plane were prepared from samples spanning the full range of purity, and examined using optical, scanning electron microscopy, and transmission electron microscopy.

Growth of the contact area between the core layer and the ceramic, which results in “dewetting” of the liquid film during bonding, is an essential element of LFAJ. Instead of opaque or translucent polycrystalline Al₂O₃, optically transparent sapphire (Al₂O₃) samples were bonded using Cu/Nb/Cu interlayers at 1150° C., and fiducial marks on the outer sapphire surface were used to mark specific regions of the interlayer/Al₂O₃ interface. By examining the same regions after a sequence of anneals at either 1150° or 1400° C., and performing quantitative measurements of the area fraction of Nb/sapphire interface, it was possible to assess the dewetting kinetics. An example of the interfacial microstructure at an intermediate stage of dewetting is shown in FIG. 2a, and the results of the dewetting kinetics measurements at 1150° C. and 1400° C. are summarized in FIG. 2b.

“Nucleation” of Nb-sapphire contact can occur at asperities on the surfaces of either the Nb or sapphire or at asperities that develop due to liquid/sapphire or liquid/Nb interface instability, or can be associated with progressive growth of ridges flanking Nb grain boundaries. This ridge growth occurs in response to etching and grooving of the Nb grain boundaries by liquid Cu. Increasing the bonding/anneal temperature raises the product of the Nb solubility and Nb diffusivity in the Cu-rich liquid and thereby the rate of Nb redistribution. These observations suggested that the design of interlayers in which the core layer solubility in the liquid is very high could be of considerable utility. The high solubility implies that thinner cladding layers help to achieve a given liquid film thickness, and in conjunction with a high diffusivity in the liquid film, may lead to very rapid growth of core-ceramic contact area.

FIG. 3 shows the strength distribution that results when polished substrates are bonded at 1400° C. with an optimum-thickness Cu film, and compares the results to those obtained when as-ground 99.5% Al₂O₃ substrates are used. Under optimized conditions, the average strength of bonded samples is a high fraction of the average strength of the unbonded reference Al₂O₃, about 75% of the bonded samples failed in the ceramic, and the Weibull modulus (14.9) was comparable to that characteristic of the unbonded Al₂O₃ (13.8). When as-ground substrates are used, the beneficial impact of liquid films remains pronounced (see data for the unpolished diffusion bond in FIG. 3). Although the average strength and Weibull modulus decrease, and interfacial fractures become more prevalent relative to an optimized joint, the changes are relatively modest, and thus, the use of as-ground substrates may be possible. Furthermore, with less aggressive grinding, the differences in fracture characteristics between joints prepared with polished and as-ground substrates may well be reduced. Thus, the process is, in principle, useful for joining materials with ground surfaces.

It would be useful to find improved materials and processes for rapid, reduced temperature bonding of ceramic materials such as alumina.

### BRIEF DESCRIPTION OF THE DRAWINGS

The foregoing aspects and others will be readily appreciated by the skilled artisan from the following description of illustrative embodiments when read in conjunction with the accompanying drawings.

FIGS. 1a and 1b are schematic drawings that show interlayer configurations before bonding and after TLP bonding with partial chemical homogenization, respectively. FIG. 1c is a schematic drawing that shows an interlayer configuration after LFAJ with discrete particles along the core layer-ceramic interface.

FIG. 2a is a micrograph that shows an interlayer-sapphire interface after partial dewetting.

FIG. 2b is a graph that shows Cu film dewetting kinetics as a function of time and temperature. Bounding curves correspond to fits to the upper and lower limits of the kinetics at 1150° C. and 1400° C.

FIG. 3 is a plot of failure probability as a function of strength for various Cu film thicknesses and substrate finishes. Not all unfilled symbols are visible.

FIG. 4 is the Ni—Nb phase diagram

FIG. 5 shows plots of failure probability versus fracture strength for a range of joined polished Al₂O₃ samples.

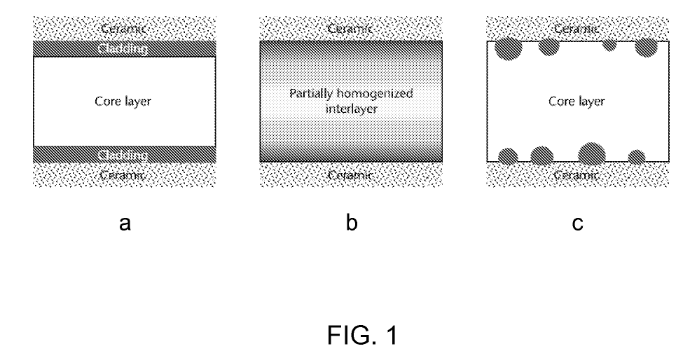

### DETAILED DESCRIPTION

It has been found that multilayer Ni/Nb/Ni interlayers can form thin transient liquid films at reduced temperatures, enabling rapid joining of alumina ceramics. The joints thus produced have reliably high strength. Bulk alumina with polished bonding surfaces and with as-ground bonding surfaces have been joined successfully. The overall interlayer composition can exceed 95 atomic percent (at %) Nb, and thereby provide an excellent thermal expansion match to alumina, alumina-matrix composites, and other materials. Fabrication of joints suitable for high-temperature applications is possible.

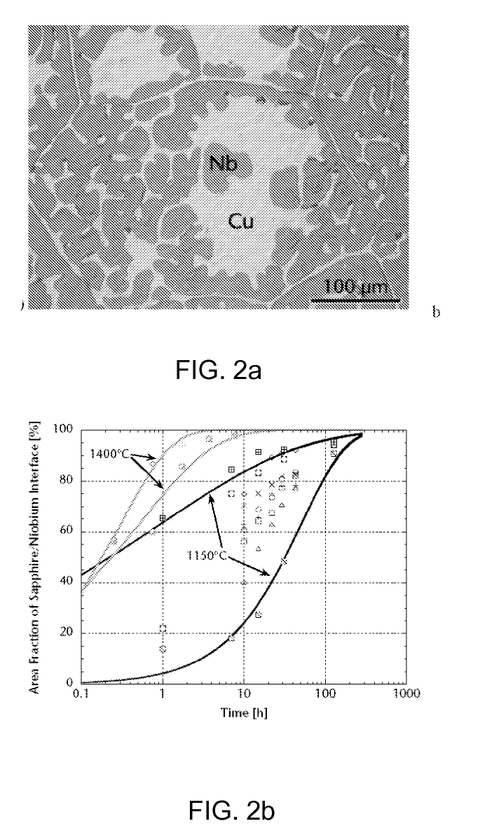

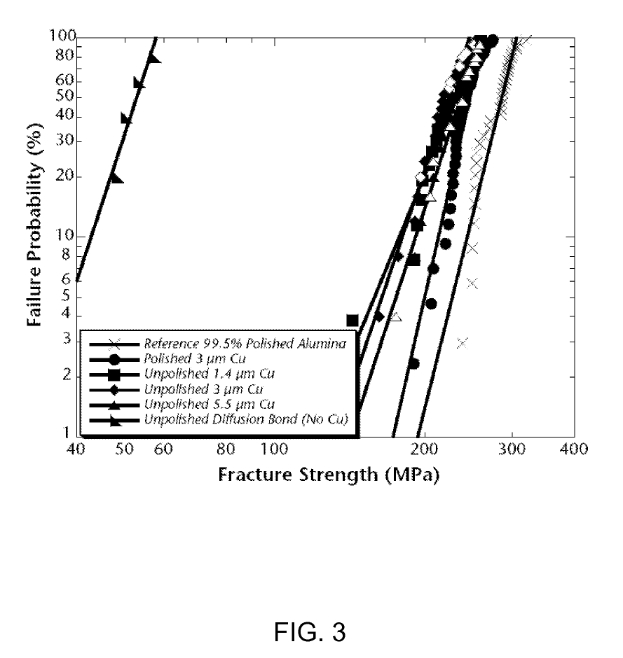

As indicated in FIG. 2b, there is a tendency for more rapid formation of Nb/Al₂O₃ contacts at higher temperature. An analysis suggests that the product of the Nb-solubility and Nb diffusivity in the liquid plays a major role in the overall rate of Nb/Al₂O₃ contact formation. For Cu/Nb/Cu interlayers, at 1150° C., the Nb-saturated liquid contains ˜0.9 at % Nb while at 1400° C. it contains ˜1.7 at % Nb, and this difference, coupled with a modest rise in the diffusivity appears to account for the enhanced contact-growth kinetics. Since Nb closely matches the thermal expansion of Al₂O₃, it was desirable to maintain Nb as the core layer material.

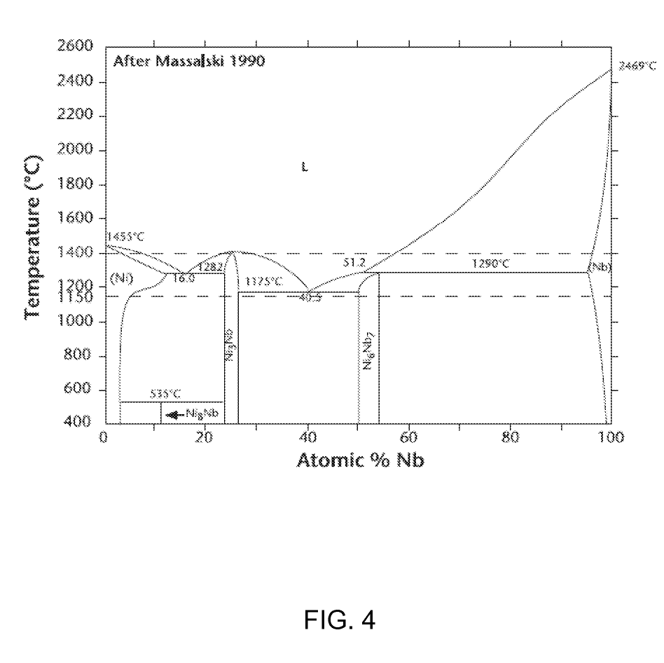

A review of the phase diagram literature revealed some attractive features in the Ni—Nb binary system, whose phase diagram is shown in FIG. 4. At 1400° C., the liquid contains more than 50 at % Nb. This is in contrast to the Cu—Nb system, in which the liquid phase in equilibrium with the Nb core layer contains less than 2 at % Nb at 1400° C. The greater solubility of Nb in the Ni—Nb system leads to an increase the rate of Nb/Al₂O₃ interface formation. Thus one can choose a metal (M) to use with Nb based on the solubility of Nb in M at the processing temperature. In one embodiment of the invention, Nb has a solubility of at least 1.7 at % in M at the processing temperature. In one embodiment of the invention, Nb has a solubility of at least 5 at % in M at the processing temperature. In one embodiment of the invention, Nb has a solubility of at least 10 at % in M at the processing temperature. In one embodiment of the invention, Nb has a solubility of at least 25 at % in M at the processing temperature. In one embodiment of the invention, Nb has a solubility of at least 50 at % in M at the processing temperature.

In one embodiment of the invention, appropriate for any material pieces one is interested in joining, another criterion is used to chose metals M₁/M₂/M₁ for the composite foil. In one arrangement, M₂ has a thermal expansion coefficient within about 20% of the thermal expansion coefficient of the material pieces. In one arrangement, M₂ has a thermal expansion coefficient within about 10% of the thermal expansion coefficient of the material pieces. In one arrangement, M₂ has a thermal expansion coefficient within about 5% of the thermal expansion coefficient of the material pieces. In one arrangement, M₂ has a thermal expansion coefficient within about 2% of the thermal expansion coefficient of the material pieces. In one arrangement, M₂ has a thermal expansion coefficient within about 1% of the thermal expansion coefficient of the material pieces.

The solubility of M₂ in M₁ is also taken into consideration. In one embodiment of the invention, M₂ has a solubility of at least 1.7 at % in M₁ at the processing temperature. In one embodiment of the invention, M₂ has a solubility of at least 5 at % in M₁ at the processing temperature. In one embodiment of the invention, M₂ has a solubility of at least 10 at % in M₁ at the processing temperature. In one embodiment of the invention, M₂ has a solubility of at least 25 at % in M₁ at the processing temperature. In one embodiment of the invention, M₂ has a solubility of at least 50 at % in M₁ at the processing temperature.

Discrete intermetallic phases may be formed at the interlayer/ceramic interface. Prior work showed that in samples bonded with Cu/Nb/Cu interlayers, tearing of interfacial Cu particles contributed significantly to the interfacial fracture toughness at room temperature, but that this contribution decreased with increasing temperature due to softening of the Cu. Intermetallic particles can contribute to toughening at higher temperatures. Ni and Cu form complete solid solutions. Thus, Ni—Cu alloy as a cladding material may produce an interfacial microstructure with both Cu-rich-Nb and/or Ni—Nb intermetallic particles at the interface, and thus, both a lower temperature and higher-temperature toughening phase.

In exemplary embodiments of the invention, joints are fabricated using a 99.9% pure, ≧98% dense Al₂O₃. Joining surfaces of 20 mm×20 mm×20 mm Al₂O₃ pieces are ground flat on a surface grinder using a 400-grit diamond wheel and some pieces are mechanically polished further using progressively finer grit size diamond suspensions. Some samples are also given a final chemical-mechanical polish using colloidal silica after mechanically polishing with a 1-μm diamond suspension.

The core layer of the multilayer Ni/Nb/Ni interlayer (composite foil) is a 99.99% pure 127-μm-thick Nb foil. In one embodiment of the invention, the thickness of the Nb foil is between about 50 μm and 200 μm. In one embodiment of the invention, the thickness of the Nb foil is between about 100 μm and 150 μm. The source for the cladding is 99.98% pure Ni wire pieces of 2 mm diameter. The Nb is cut into 20 mm×20 mm squares to match the footprint of the alumina blocks, pressed flat after cutting, and cleaned in solvents and dried. The Ni wire is cut into pieces which are cleaned, placed in alumina-coated tungsten baskets in a vacuum evaporator, and heated to melting. The Ni is deposited directly onto the Nb foil surfaces, thus forming a composite foil with three layers, Ni/Nb/Ni. The mass of Ni used results in coatings roughly 2 μm thick on each side of the Nb foil, as determined by profilometry. In one embodiment of the invention, the thickness of the Ni on each side of the Nb foil is between about 0.1 μm and 20 μm. In one embodiment of the invention, the thickness of the Ni on each side of the Nb foil is between about 1 μm and 5 μm.

Al₂O₃/Ni/Nb/Ni/Al₂O₃ assemblies are loaded into a graphite-element vacuum hot press, and joints are processed under high vacuum (pressure maintained below 7.6×10⁻⁵ Torr, equivalent to 10⁻⁷ atm). In other arrangements, processing can be performed in any non-reactive atmosphere, e.g., Ar, instead of under vacuum. A constant load of about 2.4 MPa is applied during heating at about 4° C./min, soaking at the bonding temperature of 1400° C. for either 30 min or 6 h, and cooling at 2° C./min. In other arrangements, loads between about 1 MPa and 3 MPa can be used. In yet other arrangements, the Al₂O₃/Ni/Nb/Ni/Al₂O₃ assembly can be pressed together to achieve intimate contact between the contacting surfaces and placed in a holder to maintain the contact.

After bonding, the assemblies were machined into beams 3 mm×3 mm in cross section and ˜4 cm in length, with the metal interlayer at the center of the beam. The tensile surfaces of the beams were polished to a 1-μm finish and the edges of the beams were beveled to remove machining flaws that could initiate failure. This allowed for a more meaningful measurement of the fracture strength of the joined assembly, and the observed fracture path provided insight on the relative strengths of the ceramic-metal interface and the bulk ceramic.

For comparative purposes, two bonds were made with polished Al₂O₃ blocks using an uncoated Nb foil. The same heating and cooling rates as mentioned previously were used, with a 6 h dwell at 1400° C. This solid-state bond provided a useful measure of the beneficial impact of the thin liquid film.

Beams were tested at room temperature using four-point bending. The inner span of the test jig was 9 mm; the outer span was 25 mm. Testing was performed with a displacement rate of 0.05 mm/min. Strengths were calculated from the load at failure using standard relationships derived for monolithic elastic materials.

During preparation of beams for testing, a large fraction of those in the uncoated Nb foil joints failed during machining. As a result, statistics for the surviving samples provide a somewhat distorted view of the strength characteristics of the uncoated Nb foil material. In contrast, all of the samples bonded with a Ni/Nb/Ni interlayer survived machining, and during testing, failed in the ceramic. Optimized brazes, the results of considerable research and development effort, can result in joints that are sufficiently robust that failure occurs primarily in the ceramic. But, heretofore, consistent failure in the ceramic has not been observed in any system joined with multi-layer interlayers.

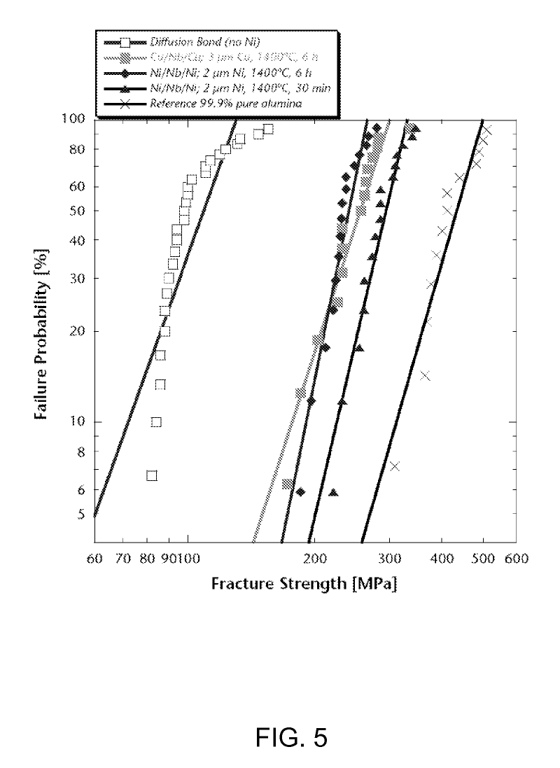

FIG. 5 provides a summary of some fracture strength data. Several features are noteworthy. For samples bonded with Ni/Nb/Ni interlayers, all 32 samples fail in the ceramic. Ceramic failures prevail even for bonding times as short as 30 minutes. In subsequent tests (data not shown), ceramic failures prevail for bonding times as short as 5 minutes. This behavior was found both for samples whose bonding surfaces were highly polished and for samples whose bonding surfaces were as-ground using a 400-grit diamond wheel. As indicated in FIG. 5, at 1400° C., >90% Nb/Al₂O₃ contact is achieved in a few hours in samples bonded with Cu/Nb/Cu interlayers. By using Ni/Nb/Ni interlayers and increasing the Nb content in the liquid from 1.7 at % to over 50 at %, the processing time required to reach a given level of Nb/Al₂O₃ contact can be reduced by roughly a factor of 30. Even after only 5 min at 1400° C., the results are superior to those previously obtained with Cu/Nb/Cu interlayers.

In one embodiment of the invention, joining surfaces of material pieces can be prepared for joining by grinding using a 400-grit diamond wheel. In one arrangement, the pieces are prepared further with a mechanical polishing step after the grinding. A multilayer M/Nb/M composite foil is positioned between the joining surfaces and intimate contact between the foil and joining surfaces is created and maintained while the entire joining assembly is heated. The heating can be performed in a non-reactive atmosphere or under vacuum. The Nb is soluble in the M. In some arrangements, a compressive force is applied to press the joining surfaces against the composite foil. In one arrangement, the material pieces are a ceramic material. In one arrangement, at least one of the material pieces has a composition different from the other material pieces.

In one embodiment of the invention, joining surfaces of ceramic materials can be prepared for joining by grinding using a 400-grit diamond (or other abrasive) wheel. In one arrangement, the pieces are prepared further with a mechanical polishing step after the grinding. A multilayer Ni/Nb/Ni composite foil is positioned between the joining surfaces and intimate contact between the foil and joining surfaces is created and maintained while the entire joining assembly is heated. The Ni/Nb/Ni composite foil can have an overall composition of between about 55 and 95 at % Nb. The heating can be performed in a non-reactive atmosphere or under vacuum. The heating can be performed at a temperature between about 1175° C. and 1600° C. In one arrangement, the heating is done at about 1400° C. The heating can be performed for between about 2 and 30 minutes or longer. In one arrangement, the heating is performed for about 5 minutes. In some arrangements, a compressive force is applied to press the joining surfaces against the composite foil. In some arrangements, the compressive force can be between about 1 and 5 MPa. The ceramic materials can be Al₂O₃ or alumina matrix composite materials, such as silica carbide composites or alumina zirconias. In one arrangement, the ceramic material is aluminum nitride. In one arrangement, at least one of the ceramic pieces has a composition different from the other material pieces.

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself.

We claim:

1. A method of joining material pieces, comprising the steps of:
providing at least two material pieces, the pieces each having a joining surface;
positioning a multilayer M/Nb/M composite foil between the joining surfaces;
creating and maintaining intimate contact between the foil and the joining surfaces to form a joining assembly; and
heating the joining assembly.

2. The method of claim 1 wherein the material pieces comprise ceramic material.

3. The method of claim 1 wherein at least one of the material pieces has a composition different from the other material pieces.

4. The method of claim 1 wherein the Nb is soluble in the M.

5. The method of claim 1 wherein creating and maintaining intimate contact comprises applying a compressive force to press the joining surfaces against the composite foil.

6. The method of claim 1 wherein the heating step is performed in a non-reactive atmosphere.

7. A method of joining ceramic pieces, comprising the steps of:
providing at least two ceramic pieces, the pieces each having a joining surface;
positioning a multilayer Ni/Nb/Ni composite foil between the joining surfaces;
creating and maintaining intimate contact between the foil and the joining surfaces to form a joining assembly; and
heating the joining assembly.

8. The method of claim 7 wherein the ceramic pieces are selected from the group consisting of Al₂O₃ and alumina matrix composite materials.

9. The method of claim 7 wherein the joining surfaces are prepared by grinding using a 400-grit abrasive wheel.

10. The method of claim 9, wherein the joining surfaces are further prepared with a mechanical polishing step after the grinding step.

11. The method of claim 7 wherein the Ni/Nb/Ni composite foil has an overall composition between about 55 and 95 at % Nb.

12. The method of claim 7 wherein creating and maintaining intimate contact comprises applying a compressive force to press the joining surfaces against the composite foil.

13. The method of claim 7 wherein applying the compressive force comprises applying a load of between about 1 and 5 MPa.

14. The method of claim 7 wherein the heating step is performed in a non-reactive atmosphere.

15. The method of claim 14 wherein the non-reactive atmosphere is a vacuum.

16. The method of claim 7 wherein the heating is performed at a temperature between about 1175° C. and 1600° C.

17. The method of claim 16 wherein the heating is performed at about 1400° C.

18. The method of claim 7 wherein the heating is performed for between about 2 and 30 minutes.

19. The method of claim 7 wherein the heating is performed for about 5 minutes.
